(19) United States
(12) Patent Application Publication
(10) Pub. No.: US 2005/0246874 A1
(43) Pub. Date: Nov. 10, 2005

(54) Carabiner with improved gate structure

(76) Inventor: Samuel Wen-chih Hsu, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/841,481

(22) Filed: May 10, 2004

(51) Int. Cl. F16B 45/02

(52) U.S. Cl. 24/598.2

(57) ABSTRACT

A carabiner with improved gate structure comprises: a metal hook and a locking mechanism; wherein the locking mechanism is composed of a safety latch, a tip, an inwardly and outwardly compressed spring, and a cylindrical latching arrangement; one end of the safety latch is pivotally cooperated with the fixed end of a metal hook, with a tip against the fixed end, and another end of the safety latch includes a clip-in opening for clip-in of the metal hook end; a cylindrical latching arrangement is sleeved to the external part of the safety latch, the invention is characterized in: providing an easier way to control the cylindrical latching arrangement and safety latch with a means that allows a orient ball bearing to slide to fit within a slotted guide.

### BACKGROUND OF THE INVENTION

1. Field of the Invention

The present invention relates to a carabiner, and more particular to a carabiner with improved gate structure, in which the control and use of a cylindrical latching arrangement can be easier and safer by allowing a orient ball bearing to slide to fit within a slotted guide, providing easier access to multiple-stage control.

2. Description of the Prior Art

Accordingly, the generating of the carabiner is to ensure the safety of operating personnel. Various carabiners with different shape and size are generated in accordance with different using environment and conditions to meet the needs of different usage. There are various types of carabiners, which can be distinguished into three categories according to their shape:

Oval Carabiners: the Earliest Shape of Carabiners.

The internal part of such carabiners has larger space to hang a number of devices without congestion. Also, the design of smooth bending side allows ropes not to be displaced with ease. Thus, such carabiners is the best choice for climbing up with hands. When using a carabiner in the event of a fall, it is better to choose Oval carabiners for operating. In addition, a Oval carabiner with two opposite open portions can be used in place of a safety carabiner. Nevertheless, such carabiners can afford the littlest strength among all carabiners.
1. “D” shaped carabiners: the shape of such carabiners is designed to afford strike through the “D”-shaped “|” line, so that they can afford the greatest strike and load. They have lighter weight than Oval carabiners with same size and same materials, but bear greater strength. Owing to the design of the gate in “D” shaped carabiners, the use of general carabiners or ensure the security of appliances has become easier.
2. Asymmetrical “D” carabiners: its appearance resembles “D” shaped carabiners, but one of its end side is narrowed in order to reduce weight. Its advantage is: the opening of the gate is large so that compared with “D” shaped carabiners, it is easier for such carabiners to hook an equipment or acertain security of the equipment, while the internal space of such carabiners is smaller than the space of same-sized “D” shaped carabiners and Oval carabiners.

The gate structure as described above is the movable part in the carabiner. In conventional appliances, nearly all devices have to been put into or token out from a carabiner through a gate. In order to increase security, a locking mechanism is usually installed on the gate. Such carabiners are usually used in places that particularly need to ensure security, such as in the event of a fall, ensuring security, or used at the first ensured points in long-distance climbing.

Many patents have been issued to improve the carabiner with locking mechanism on a gate structure, such as recent U.S. Pat. No. 6,588,076. Unfortunately, conventional carabiners cause many inconvenience to both manufacturers and users.

As shown in FIG. 1A to 1D, in a conventional carabiner 1 wherein a vertical elongated slot 12 is defined on the surface of a cylindrical locking element 11. Then, a screw-type spring 13 is loaded in the internal part of the cylindrical locking element 11 with one end fixed and another end hooked into the elongated slot 12. Therefore, when the cylindrical locking element 11 is rotated, the screw-type spring is in stressed status because the elongated slot 12 is rotated. After users release the cylindrical locking element 11 with fingers, the cylindrical locking element 11 goes back to the original locking position by the force of the screw-type spring.

However, such a structure may bring much inconvenience to manufacturers or users. The problems include the internal space of the cylindrical locking element is too narrow to load a screw-type spring, and loading a screw-type spring defined on a vertical elongated slot is not easy. Aside from these, since the cylindrical locking element is locked and released only by the elasticity of the screw-type spring, the screw-type spring may lose its elasticity, which further affects users' safety.

Accordingly, the present invention has been made with long time effort to solve the above-mentioned problems occurred in the prior art.

### SUMMARY OF THE INVENTION

Accordingly, the purpose of the present invention is to provide a carabiner with improved gate structure. The carabiner with improved gate structure according to the present invention includes a metal hook and a locking mechanism. The metal hook is generally designed as a C-shaped or D-shaped body, in which a body portion is disconnected as a gate loaded with a locking mechanism.

Provided locking mechanism is composed of a safety latch, a tip, an inwardly and outwardly compressed spring, and a cylindrical latching arrangement. Wherein, the safety latch is a shaft with a recessed notch having an inwardly compressed spring and a tip, which is pivotally attached to the fixed end of the metal hook and against the fixed end at one time in order to control the largest sway movement of the locking mechanism. Another end of the safety latch is a clip-in end, in which a axial punch cooperates with a bar for the hook-up of the metal hook end. Whether the safety latch 31 and metal hook 21 is hooked up or not can be controlled by the cylindrical latching arrangement 4. When the cylindrical latching arrangement is sleeved to the outer part of the safety latch, it is push by a compressed spring loaded on the outer part of the safety latch. A tilting slotted guide on interior wall of the cylindrical latching arrangement is used to fit with the orient ball bearing predetermined on the safety latch wall. Therefore, users can easily clip the outer part of the cylindrical latching arrangement with fingers, and then rotate and displace it pivotally, which makes the opening of said gate easier and more convenient. When locking said gate, after the locking mechanism is returned to its original position, the cylindrical latching arrangement can be pushed backward to a fixed position with little force through compressed springs, which accelerates the control and use of said locking mechanism.

Another objective of the present invention is to provide a carabiner with improved gate structure, wherein the cylindrical latching arrangement and the safety latch is operated by allowing the orient ball bearing to slide and fit within the slotted guide, which permits easier control and facilitates assembling.

Another objective of the present invention is to provide a carabiner with improved gate structure, in which the life of the cylindrical latching arrangement and safety latch can be increased by allowing a orient ball bearing to be slid to fit within a slotted guide.

Still another objective of the present invention is to provide a carabiner with improved gate structure, wherein varying slotted guides defined in the interior wall of the cylindrical latching arrangement can be designed for multiple-mode control suitable for various place use.

The above purposes and structure of the present invention will be more apparent from the following detailed description taken in conjunction with the accompanying drawings.

### BRIEF DESCRIPTION OF THE DRAWINGS

FIG. 1A is an assembled sectional view of a conventional carabiner.

FIG. 1B is a three-dimensional view of a conventional carabiner.

FIG. 1C is an illustration showing an embodiment of a conventional carabiner.

FIG. 1D is an illustration showing how to unlock a conventional carabiner.

FIG. 2 is a three-dimensional view of the present invention.

FIG. 3 is a three-dimensional sectional view of the present invention.

FIG. 4 is an assembled sectional view of the present invention.

FIG. 5A is an illustration showing the location of the orient ball bearing and slotted guide without movement according to the present invention.

FIG. 5B is an illustration showing the location of the orient ball bearing and slotted guide during movement according to the present invention.

FIG. 5C is an illustration showing the location of the orient ball bearing and slotted guide after movement according to the present invention.

FIG. 6 is an illustration showing the opening action in the present invention.

FIG. 7A is a graphic showing the first embodiment of the slotted guide according to the present invention.

FIG. 7B is a graphic showing the second embodiment of the slotted guide according to the present invention.

FIG. 7C is a graphic showing the third embodiment of the slotted guide according to the present invention.

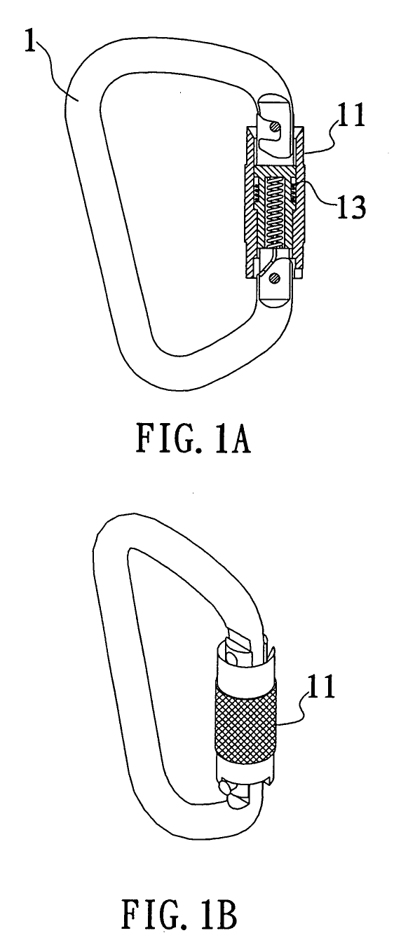

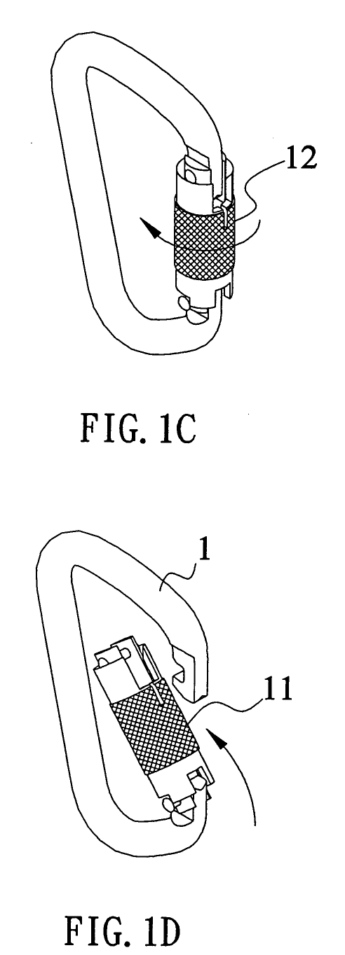

### DETAILED DESCRIPTION OF THE PREFERRED EMBODIMENTS

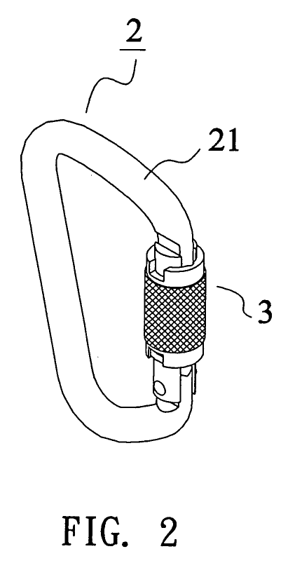

In the carabiner with improved gate structure of the present invention, as shown in FIG. 2, the carabiner with improved gate structure 2 mainly composes a metal hook 21 and a locking mechanism 3. The metal hook 21 is approximately shaped as, a C or D-type body, wherein a body portion is disconnected as the use of a gate and a locking mechanism 3 is provided on the gate.

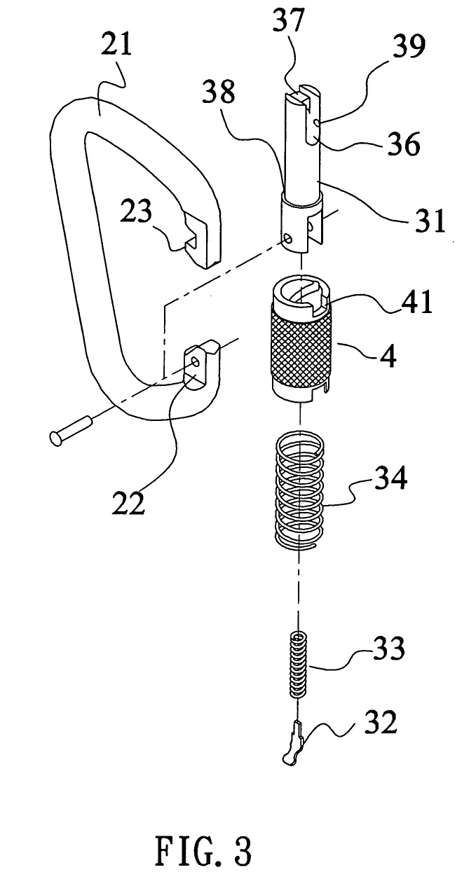

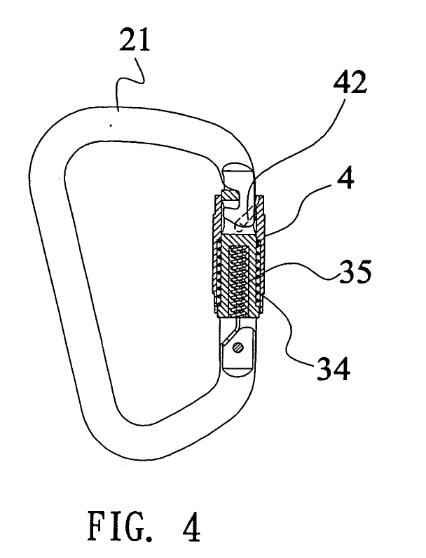

Referring to FIGS. 3 and 4, the locking mechanism 3 is composed of a safety latch 31, a tip 32, an inwardly and outwardly compressed spring 33, 34, and a cylindrical latching arrangement 4, in which said safety latch 31 is a shaft with each end is double-edged. An axial recessed notch 35 is defined on part of the shaft to load a inwardly compressed spring 33 and tip 32. When the tip 32 with an outer arc end is pushed outward by the inwardly compressed spring 33, its outer arc end is against the interior fringe of the fixed end 22 on the metal hook. After the fixed end of a safety latch 31 is pivotally cooperated with the fixed end 22 of the metal hook, tip 32 will be against the interior fringe of the metal hook's fixed end. This both controls the maximum limit position of the safety latch 31, and urges the safety latch 31 to go back to the locking position as the tip 32 and the fixed end of the metal hook is against each other when the inwardly compressed spring 33 is pushed forward with backward elasticity, by releasing the control of the safety latch 31 through the arc fringe of the fixed end on the metal hook.

Another end of said safety latch 31 is a clip-in end, by which a axial punch 36 cooperates with bar 37 for hook-up of the metal hook. Once hook up, locking can be secured by sleeving the cylindrical latching arrangement 4 on the outer part of the safety latch. Therefore, whether the safety latch 31 and metal hook 21 is hooked up or not can be controlled by the cylindrical latching arrangement 4.

Before the cylindrical latching arrangement 4 is sleeved to the outer part of a safety latch 31, an outwardly compressed spring 34 needs to be loaded on the outer part of the safety latch 31, one end of said outwardly compressed spring 34 is against toward the outer flange of safety latch 38. After the cylindrical latching arrangement 4 is sleeved to the outer part of a safety latch, another end of the outwardly compressed spring 34 is then against toward the interior ring of the cylindrical latching arrangement 4. Accordingly, when said cylindrical latching arrangement 4 is pivotally displaced, the outwardly compressed spring 34 is stressed to store up its backward elasticity.

As shown in the illustrated example, the surface of the cylindrical latching arrangement 4 has a predetermined pattern to facilitate users' clip and control with fingers. A open portion 41 is formed on the hook end of the metal hook. In general locking position, the open portion is located on the lateral side of the metal hook end so that said safety latch cannot sway to be displaced. When the open portion is exactly located ahead the metal hook end, said safety latch can sway to be displaced and the purpose of locking can be achieved.

As shown in the illustrated example, a tilting slotted guide 42 is defined on the interior wall of the cylindrical latching arrangement 4. A upward extending upwardly vertical stage slot 421 and a downward extending downwardly vertical stage slot 422 are provided on the slotted guide 42, which is appropriately fit with a orient ball bearing 39 predetermined on exterior wall of the safety latch. As such, when users clip the cylindrical latching arrangement 4 with fingers, they first pull it down and then rotate it. As a result, the cylindrical latching arrangement 4 is rotated by making the internal slotted guide 42 and the orient ball bearing 39 on exterior wall of the safety latch slide towards each other to change the orientation of the open portion 41. Thus, the purpose of controlling locking and unlocking can be achieved.

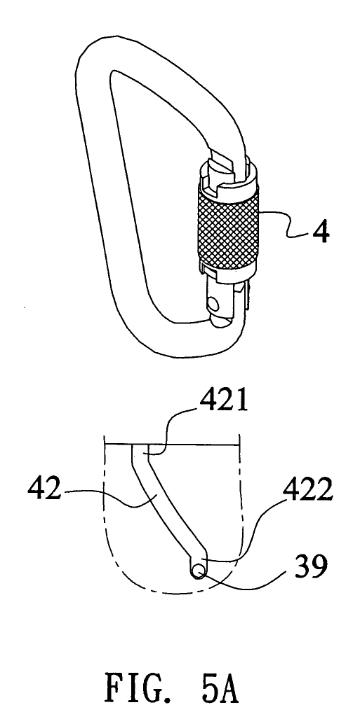

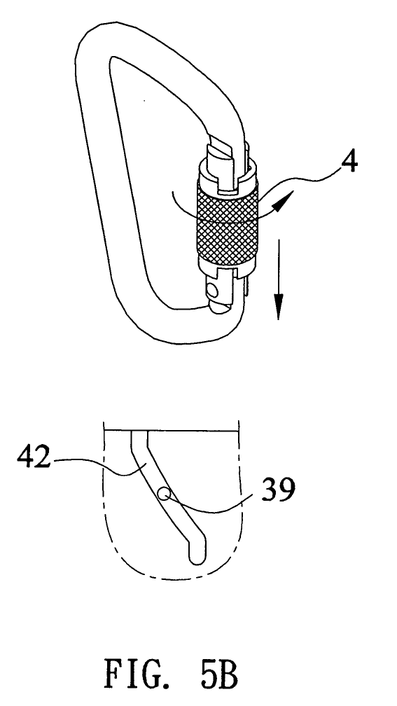

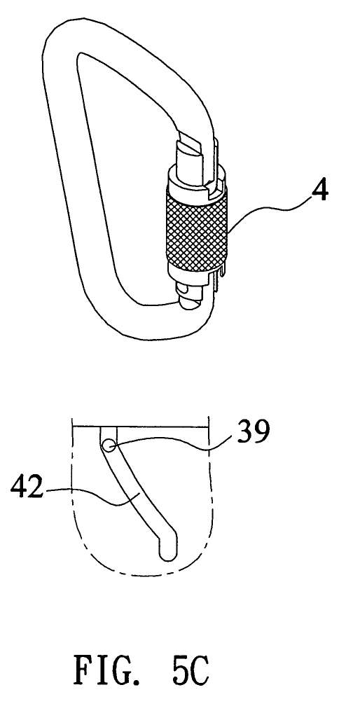

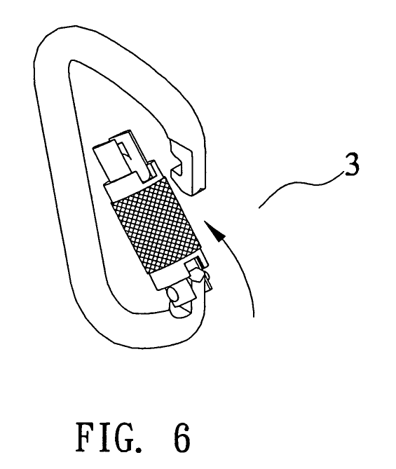

As to the sliding movement between the slotted guide on the interior wall of cylindrical latching arrangement and the orient ball bearing, FIG. 5A to 5C show the relation of displacement between said slotted guide and orient ball bearing. As shown in FIG. 5A, in said locking position, the orient ball bearing 39 is first positioned in the downwardly vertical stage slot 422 of said slotted guide 42. When users attempt to release lock, they need to pull down the orient ball bearing 39 away from said downwardly vertical stage slot 422, then rotate the cylindrical latching arrangement 4. Since the orient ball bearing 39 is immovable, the mutual embedded position between said slotted guide 42 and orient ball bearing 39 is changed due to the rotation of said cylindrical latching arrangement 4 (as shown in FIG. 5B); as shown in FIG. 5C, as the orient ball bearing 39 enters the upwardly vertical stage slot 421 of said slotted guide 42, the open portion 41 of said cylindrical latching arrangement 4 is completely moved backward from the metal hook end. Also, as shown in FIG. 6, when pressing the locking mechanism 3 slightly, the safety latch 31 departs from the metal hook end 23; when releasing the stressed locking mechanism 3, the entire locking mechanism 3 returns to its original position in accordance with the fixed metal hook end and tip 32 with stress pushed forward by the inwardly compressed spring 33. In the meantime, said cylindrical latching arrangement 4 goes back to original locking position by the elasticity of the outwardly compressed spring 34.

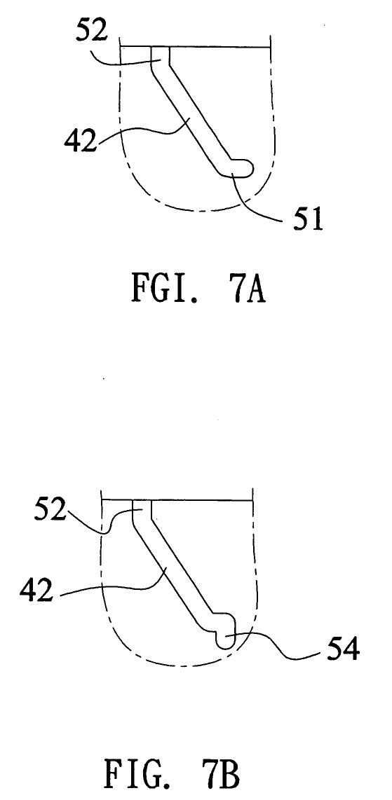

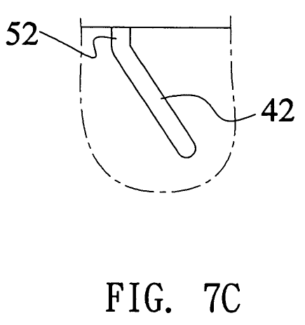

The slotted guide defined on the interior wall of the cylindrical latching arrangement described above can be designed in various shapes and types to enable multi-level control, which is suitable for more places. As shown in FIG. 7A, a horizontal portion 42 is formed on the bottom of the tilting slotted guide 42 and a vertical portion 52 is formed on the upper end of the tilting slotted guide 42; as shown in FIG. 7B, a L-shaped bending portion 54 on the bottom of the tilting slotted guide 42 and a vertical portion 52 is formed on the upper end; as shown in FIG. 7C, a vertical portion 52 is formed on the upper end of the tilting slotted guide 42. Either the vertical portion or horizontal portion provides earlier-to-later stage for sliding movement between said orient ball bearing and slotted guide. Therefore, the arrangement of said vertical portion or horizontal portion provides orientation control applicable to more places.

As described above, the control of the carabiner with improved gate structure of the present invention, through providing a cylindrical latching arrangement and safety latch in which a orient ball bearing is slid to fit within a slotted guide, can be easier, which facilitates the assembling and increases carabiner life. Also, the present invention has not yet opened to public, it is then complied with the conditions of allowable patents.

It should be noted here, although the above-mentioned embodiments of the present invention have been described for illustrative purposes, those skilled in the art will appreciate that various modifications, additions and substitutions are possible, without departing from the scope and spirit of the invention as disclosed in the accompanying claims.

1. A carabiner with improved gate structure, comprising:
a metal hook and locking mechanism; a portion body of the metal hook is disconnected as a gate with a locking mechanism provided thereof; wherein the locking mechanism comprises:
a safety latch with its one end pivotally cooperated with a fixed end of the metal hooks so that the safety latch sways around the fixed end of the metal hook. One end of the shaft is provided with an axial recessed notch to load an inwardly compressed spring and tip. Another end is a clip-in end by which a axial punch cooperates with a bar for hook-up of said metal hook;
a cylindrical latching arrangement, which is sleeved to the outer part of said safety latch with the hook end close to the metal hook has a open portion. In general locking position, the open portion is located on the lateral side of the metal hook end so that said safety latch cannot sway to be displaced. When the open portion is exactly located ahead the metal hook end, said safety latch can sway to be displaced and the purpose of locking can be achieved;
the feature includes: a tilting slotted guide is defined on the interior wall of a cylindrical latching arrangement, when said cylindrical latching arrangement is sleeved to the outer part of the safety latch, a orient ball bearing predetermined on the exterior wall of said safety latch is fit within said slotted guide, said cylindrical latching arrangement is rotated by external force. Due to the sliding movement between said slotted guide and orient ball bearing, the front-to-rear displacement can be achieved.

2. The carabiner with improved gate structure as claimed in claim 1, wherein the outer part of said safety latch is provided with an outwardly compressed spring to resist against the backward elasticity generated when the cylindrical latching arrangement is slid downward and displaced. Once its stress is eliminated, said cylindrical latching arrangement can be pushed toward the locking position.

3. The carabiner with improved gate structure as claimed in claim 1, wherein said slotted guide defined in the interior wall of the cylindrical latching arrangement is a tilting slotted guide.

4. The carabiner with improved gate structure as claimed in claim 1, wherein said slotted guide defined in the interior wall of the cylindrical latching arrangement is a tilting slotted guide with its upped end has a vertical portion.

5. The carabiner with improved gate structure as claimed in claim 1, wherein said slotted guide defined in the interior wall of the cylindrical latching arrangement is a tilting slotted guide with a horizontal portion formed on its upper end.

6. The carabiner with improved gate structure as claimed in claim 1, wherein said slotted guide defined in the interior wall of the cylindrical latching arrangement is a tilting slotted guide with a vertical portion formed on its bottom.

7. The carabiner with improved gate structure as claimed in claim 1, wherein said slotted guide defined in the interior wall of the cylindrical latching arrangement is a tilting slotted guide with a horizontal portion formed on its bottom
